(19) United States
(12) Patent Application Publication
(10) Pub. No.: US 2019/0073501 A1
(43) Pub. Date: Mar. 7, 2019

(54) USE OF PRINTED LABELLED INFORMATION IDENTIFYING MEANS USING PLURALITY LIGHTING MECHANISM TO REDUCE DISTURBING LIGHT

(71) Applicant: Chi Lick Chiu, Hong Kong (HK)

(72) Inventor: Chi Lick Chiu, Hong Kong (HK)

(21) Appl. No.: 16/164,753

(22) Filed: Oct. 18, 2018

Related U.S. Application Data
(63) Continuation of application No. 15/696,153, filed on Sep. 5, 2017.

(51) Int. Cl. G06K 7/10; G06K 7/14

(52) U.S. Cl. CPC G06K 7/10722; G06K 7/1413

(57) ABSTRACT

Eliminate or reduce the impact of disturbing light in printed information label recognition applications using single- and multi-shot external flashing coupled with intelligent processing. A shelf imager can acquire shelf images for printed information label localization and recognition. An external flashlight can provide at least one flashing condition/pose for shelf image acquisition in addition to lighting associated with the enclosed environment. A disturbing light region (DLR) detector can analyze all or a portion of the acquired shelf images for disturbing light to determine whether additional images need to be acquired using different flashing conditions provided by the single- or multi-shot external flashlight or whether full or portion of acquired images need to be analyzed by a printed information label locator and recognizer. A printed information label locator and recognizer can analyze all or a portion of the acquired images to localize and recognize data printed on the printed information labels.

### CROSS-REFERENCE TO RELATED APPLICATIONS

This application is a continuation of application Ser. No. 15/696,153, filed Sep. 5th, 2017. Any publications, patents and patent applications referred to herein are incorporated by reference in their entirety to the same extent as if each individual publication, patent or patent application was specifically and individually indicated to be incorporated by reference in its entirety.

### FIELD OF THE INVENTION

This present disclosure is generally related to systems, devices and/or methods for eliminate or reduce the impact of disturbing light in printed information label recognition applications using single- and multi-shot external flashing coupled with intelligent processing.

### BACKGROUND OF THE DISCLOSED TECHNOLOGY

Imaging disturbing light can impede or reduce printed label information recognition. For example, disturbing light has interfered with machine-readable code detection and recognition of machine-readable codes used in retail applications wherein various image-based and video-based analytics are being developed. Automated systems for determining the spatial layout of products in a store via machine-readable code recognition are currently being developed but depend on accurate machine-readable code recognition. Machine-readable code recognition is a problem mostly due to disturbing light caused by lighting existing in the environment where machine-readable codes are being used. This problem is further exacerbated when machine-readable codes are covered by clear plastic coatings. The problem equally applies to the recognition of other patterns or numbers, e.g., such as Machine-readable codes and UPC codes that are used to identify product and inventory and also applies in non-retail applications wherein accurate printed label information detection and recognition is necessary.

Disturbing light refers to saturated regions in images typically caused by reflection from the surface of an object being imaged and can impede recognition of printed information. For example, when a disturbing light region overlaps a machine-readable code region, image processing cannot resolve the bars in most cases because the machine-readable code may be completely white or wiped out in the images due to gray-level saturation. An ideal solution is to have an imaging system that does not generate images with disturbing light regions in the first place; but due to the lighting variability in and across stores and the constraints in imaging systems, it is not feasible in practice. To make the matter worse, most price-labels are inserted in a plastic strip at the facing of the shelf, where the plastic has a high degree of reflection and is positioned at an angle that reflects light from ceiling facility flashing into the direction of the imaging system. This combination of lighting and imaging geometry and high refection tends to increase the prevalence of disturbing light when imaging labels are located on shelf facing.

What is needed are systems and methods that can overcome printed label information recognition problems caused by disturbing light. The present inventors describe systems and methods to enhance label information recognition rates by reducing the effect of disturbing light on printed labels during imaging.

### SUMMARY OF THE INVENTION

One aspect of the present invention to enhance printed label information (e.g., machine-readable code) recognition rates by reducing the effect of disturbing light during imaging.

It is another feature of the present invention to provide an imaging and flashing system with disturbing light mitigation to eliminate the negative impact of disturbing light on the ability to recognize printed label information in commercial and industrial applications.

It is yet another feature that the imaging and flashing system and methods can utilize a multi-shot external flashlight coupled with algorithmic control and processing to eliminate the degradation of printed label information recognition.

In accordance with aspects of an embodiment of the present invention, an imaging and flashing system can be provided that include a store shelf imager, which can acquire shelf images for machine-readable code localization and recognition, an external flashlight, which can provide at least one additional flashing condition (e.g., pose) for shelf image acquisition, a disturbing light region (DLR) detector, which can analyze full or partial areas of the acquired images for disturbing light to determine whether additional images need to be acquired using different flashing condition(s) provided by the multi-shot external flashlight or whether full or portion of acquired images need to be analyzed by a machine-readable code locator and recognizer, which can also analyze full or partial areas of acquired images to localize and recognize machine-readable codes.

In accordance with aspects of another embodiment of the present invention, a method in the form of a computer-controlled processing sequence can be provided that acquires shelf images without an external flashlight (e.g., if store lighting is on) or with the first pose of the external flashlight (e.g., if store lighting is off), detects disturbing light regions of interest (DLRs) in these images, acquires images with a different pose of external flashlight for any sub-imaging system with at least one disturbing light DLR detected, checks if the disturbing light remains on this new set of images for those detected disturbing light DLRs, and, if not, replace the detected disturbing light DLRs with corresponding regions in the new set of images to accomplish machine-readable code recognition.

In accordance with another feature of the embodiments of the present invention, the external flashlight can be a controllable multi-shot external flashlight.

It is also a feature of the present invention to enable repeat checking if disturbing light remains on any new set of images for those detected disturbing light DLRs and, if so, to replace the detected disturbing light DLRs with corresponding regions in the new set of acquired images to accomplish printed label information recognition until no more detected disturbing light DLRs remain, or all poses of a multi-shot flashlight have been explored.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a system in accordance with embodiments of the present invention;

FIGS. 2a-2c illustrates an external flashlight in accordance with embodiments of the present invention, and in particular (a) one-pose flashlight, (b) Discrete N-pose flashlight, and (c) Continuous/controllable multi-shot flashlight;

FIG. 3 illustrates an imaging and processing sequence for a disturbing light mitigation system using multi-shot flashing in accordance with an embodiment of the present invention;

FIG. 4 illustrates a drawing of a prototype for a robotic imaging system with controllable external flashlight for achieving disturbing light mitigation in accordance with embodiments of the present invention;

### DETAILED DESCRIPTION OF EMBODIMENTS OF THE DISCLOSED TECHNOLOGY

There is growing interest by retail enterprises in having systems that use image acquisition for accelerating the process of determining the spatial layout of products in a store using printed label information recognition. Although “machine-readable codes” will be described as the label information for purposes of the rest of this disclosure, it should be appreciated that imaging could equally apply to other patterns (e.g., such as Machine-readable codes) and serial numbers (e.g., such as UPC codes). Furthermore, the solutions disclosed herein can apply to several environments including retail, warehouse and manufacturing applications, where identifying machine-readable coded item location is desired. The invention described herein addresses a critical failure mode of such a system. In particular, the present invention is generally aimed at eliminating or reducing the impact of imaging disturbing light (e.g., reflection of the light fixtures, light, etc.) on the overall printed label information recognition rate.

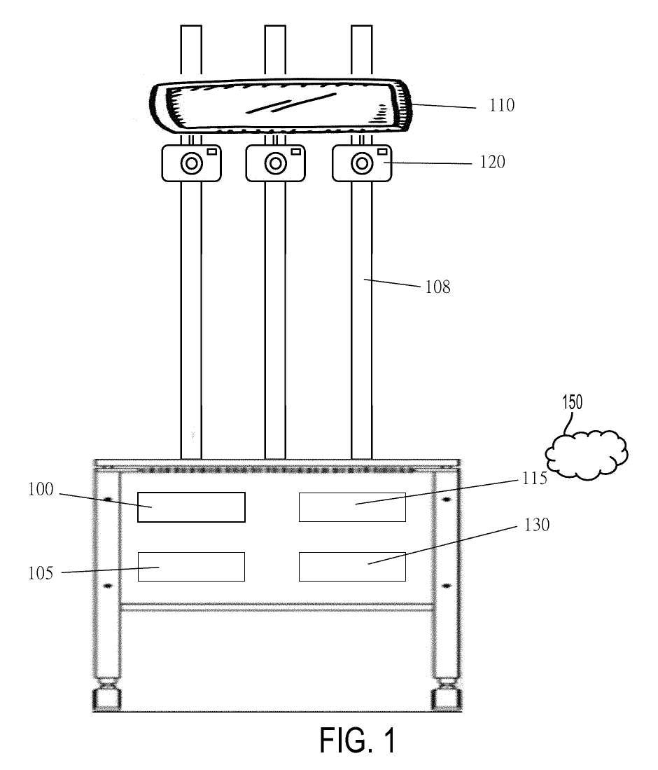

In FIG. 1, an imaging and flashing system 100 with disturbing light mitigation for eliminating the impact of disturbing light in imaging to the degradation of machine-readable code recognition is illustrated. The invention is taught in the context of a retail setting for exemplary purposes, but as stated hereinbefore this should not be taken as a limitation with respect to its scope or application. This imaging and flashing system 100 can be robotic, e.g., wheeled 107 for movement along flooring and have mechanized tracking 108 to move imaging equipment vertically with mechanical movements that can be computer-controlled 105. The imaging and flashing system can also be locally controlled or remote controlled via a data network 150. The heart of the imaging and flashing system 100 utilizes the addition of an external flashlight 110 coupled with algorithmic control and processing unit 15 to eliminate the degradation of machine-readable code recognition. The imaging and flashing system 100 can include: (1) a store shelf imager 120 (e.g., camera), which can acquire shelf images for machine-readable code localization and recognition; (2) the external flashlight 110, which can provide at least one additional flashing condition (e.g., varying poses) for shelf image acquisition; (3) a disturbing light region (DLR) detector 130, which can analyze the entirety, or a portion of each acquired image for disturbing light to determine whether additional images for each analyzed image need to be acquired using different flashing conditions provided by the external flashlight 110, or acquired images without disturbing light issues in the region (or where additional imaging has cleared up disturbing light issues) can be analyzed by machine-readable code locator and recognizer 140; and (4) a machine-readable code locator and recognizer 140, which can analyze acquired images to localize and recognize machine-readable codes located in the region thereon. Although the entire label could be analyzed for disturbing light, processing can be simplified and expedited when only the portion of a label that carries the machine-readable code information, which is the disturbing light region, is analyzed. In this case, the system is only concerned with disturbing light in the bar-coded portion of a larger label. If this is the case, the system analyzes only that bar-coded portion (disturbing light region) of a larger label for disturbing light issues when following the above-described process. It should be appreciated that the disturbing light region (DLR) detector 130 and the machine-readable code locator and recognizer 140 can be provided as modules in the algorithmic control and processing unit 115. Robotic controller 105 can also be incorporated to function under a shared microprocessor as part of algorithmic control and processing unit 115.

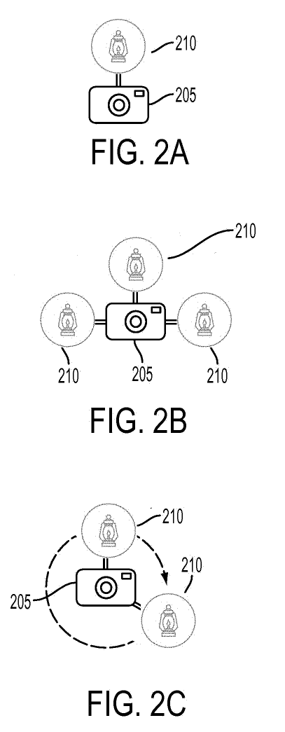

In FIGS. 2a-c, additional aspects of an external flashlight in accordance with embodiments of the present invention are illustrated in the form of a multi-shot external flashlight 210 associated with a camera 205. FIG. 2a illustrates an external flashlight 210 set up for a fixed pose of flashing above a camera 205. FIG. 2b illustrates an external flashlight 210 similar to FIG. 2a, but having the ability to provide multiple discrete poses of flashing around the camera 205. As shown in FIG. 2b, external flashlight 210 can be placed into three discrete poses-pose 1, pose 2, and pose 3-by a system controller (see FIG. 1). Then, as shown in FIG. 2c, the external flashlight 210 can be placed in multiple positions, e.g., up to 360 degrees, around the camera 205.

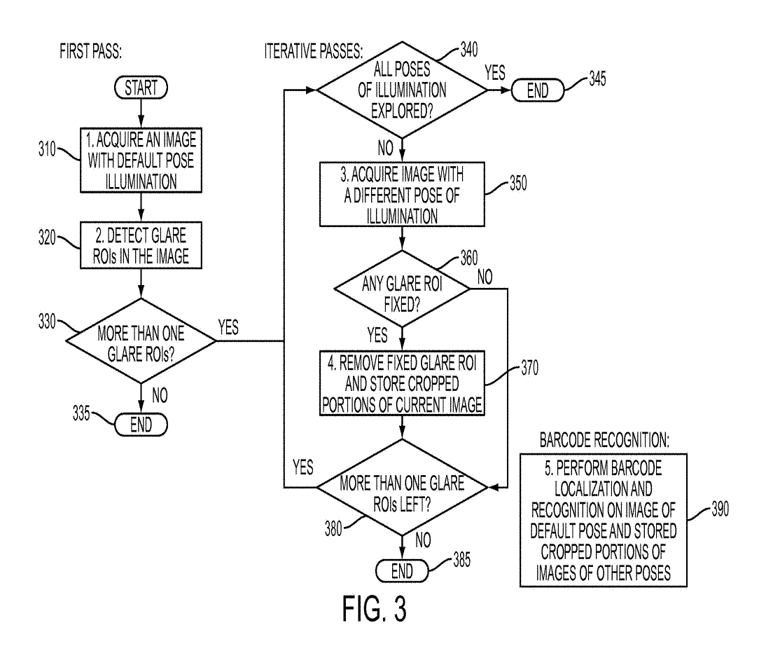

In FIG. 3, a flow chart of a method in accordance with features of the present embodiments is shown. The method begins with a first pass where an image is acquired using the default pose flashing as shown in Block 310 and detects whether there is at least one disturbing light DLR in this image, as shown in Block 320. If not as determined in Block 330, the image is sent to the machine-readable code locator and recognizer for machine-readable code recognition, as shown in Block 390; and the process stops, as shown in Block 335.

If more than one disturbing light DLR is detected, then iterative passes are performed while utilizing additional multi-shot flashing to substitute/remove the disturbing light DLRs detected from the first pass acquired images, as shown in Block 340, then the process will end at shown in Block 345. But, if it is determined that not all poses of the flashing have been explored, as shown in Block 340, then an image with a different pose of the flashing is acquired, as shown in Block 350.

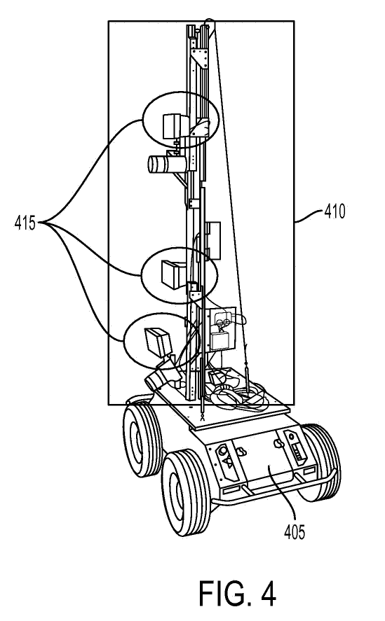

In FIG. 4, a drawing of a prototype imaging system is shown. The prototype system is robotically controlled 405 and includes an imaging section 410, including a 3-camera 2-position (up or down) hardware with supplementary flashing 415, which was proven suitable for imaging store shelves up to 6′ tall. It can be assumed that a store shelf imaging system would operate during the store hours, i.e., when the store lights are on. Under this assumption, the store flashing will provide the default-pose flashing that is not controllable by the present imaging system. Additionally, a controlled pose of an external light source into the system for disturbing light mitigation is considered and can be implemented into processing. A controlled pose can be selected by taking into account the store layout, camera geometry, etc.

When the method was applied to the acquired images, the detected disturbing light DLRs is acquired at blocked areas on the shelves. In some instances, some disturbing light DLRs indeed line-up with shelf-product machine-readable codes while some do not. It should also be noted that in some cases there are no disturbing light DLR detected. In such cases, no reprocessing is needed. However, for those images with at least one detected disturbing light DLRs, further image acquisition and processing was needed so that system users could recover potential issues of machine-readable code not recognized due to disturbing light. That is, the method continues with the iterative passes for these locations of the aisle and shelf.

Different poses of flashing at the same blocked shelf location can be applied to acquire multiple images of different exposure. The purpose of changing flashing pose (condition) is to either shift the location of disturbing light regions or ideally eliminate any disturbing light.

The corresponding cropped portions of previously detected disturbing light DLRs acquired at the detected shelf locations can be acquired using an additional pose of external flashing. These cropped images contain the bar codes. It should be noted that, for the mock retail setting and example, one additional pose effectively removed all detected disturbing light DLRs on the shelf.

For sensing, the image is acquired while more than one flash lights are used. For processing, the green-channel of the acquired images will be treated as the 1^{st} pose images since the camera green sensitivity line-up with GREEN flashing. Similarly, the RED-channel and BLUE-channel of the acquired images will correspond to 2^{nd} pose and 3^{rd} pose images, respectively. Since RED, GREEN, and BLUE lights can be arranged at different poses and can sense the scene with a camera with matching R/G/B sensitivities, a system can be able to simultaneously acquire images under multiple poses of flashing.

What is claimed:

1. A system for reducing disturbing light while reading labelled information labels located in an enclosed environment using multi-shot flashing, comprising:
a shelf imager, the shelf imager for acquiring shelf images for labelled information label localization and recognition;
a labelled information label locator and recognizer analyzing all or a portion of acquired images to localize and recognize labelled information labels;
an external flashlight, the external flashlight for providing at least one flashing condition for shelf image acquisition in addition to lighting associated with the enclosed environment; and
a disturbing light region (DLR) detector, said disturbing light region (DLR) detector for analyzing at least a portion of the acquired shelf images for disturbing light to determine whether additional images of the shelf images need to be acquired for recognition using a different flashing condition provided by the external flashlight, wherein the external flashlight further comprises three multi-shot external flashlights, and wherein different flashing conditions are provided onto the shelf by three different positions of the three multi-shot external flashlight around the shelf imager and each of three multi-shot external flashlights are assigned a different color selected from: GREEN, RED, BLUE, and at least one of the three multi-shot external flashlights is a RGB camera; wherein the labelled information labels contain data including machine-readable code.

2. The system of claim 1, wherein the order of imaging of the poses of the multi-shot external flashlight for image capture is determined based on image analysis of previously acquired shelf images,
wherein the positions of the poses of the multi-shot flashlight for image capture is determined based on knowledge of shelf configuration of a store and environmental lighting of the store,
wherein the external flashlight further comprises a multi-shot external flashlight,
wherein the multi-shot external flashlight provides different flashing conditions onto the shelf by varying positions of the multi-shot external flashlight around the shelf imager;
and wherein the external flashlight further comprises three other multi-shot external flashlights and wherein the different flashing condition are provided onto shelves by three different positions of the three multi-shot external flashlight around the shelf imager and each of three multi-shot external flashlights are assigned a different color selected from: GREEN, RED, and BLUE.

3. A system for reducing disturbing light while reading labelled information labels located in an enclosed environment using multi-shot flashing, comprising:
a shelf imager, the shelf imaging for acquiring shelf images for labelled information label localization and recognition;
a labelled information label locator and recognizer analyzing all or a portion of acquired images to localize and recognize labelled information labels;
an external flashlight, the external flashlight for providing at least one flashing condition for shelf image acquisition in addition to lighting associated with the enclosed environment; and
a disturbing light region (DLR) detector, the disturbing light region (DLR) detector for analyzing at least a portion of the acquired shelf images for disturbing light to determine at least one of whether additional images of the shelf images need to be acquired for recognition using at least one different flashing condition provided by the external flashlight, and whether full or portion of acquired images need to be analyzed by machine-readable code locator and recognizer; wherein said external flashlight further comprises a multi-shot external flashlight, and wherein the multi-shot external flashlight provides at least one different flashing condition on the shelf provided by varying positions of the multi-shot external flashlight around the shelf imager; wherein said external flashlight further comprises three multi-shot external flashlights, and wherein multi-shot external flashlight provides different flashing conditions on the shelf provided by three different positions of the three multi-shot external flashlight around the shelf imager; wherein said external flashlight further comprises three multi-shot external flashlights, and wherein multi-shot external flashlight provides different flashing condition onto the shelf by providing at least one of three different positions of the three multi-shot external flashlight around the shelf imager and each of three multi-shot external flashlights are assigned a different color selected from: GREEN, RED, BLUE, and the shelf imager is a RGB camera.

4. A method for reducing disturbing light while reading labelled information labels using multi-shot flashing, comprising:
(a) acquiring shelf images using external flashing;
(b) detecting a first set of disturbing light regions of interest from the shelf images;
(c) acquiring a new set of shelf images with a different pose from an external flashlight for at least one disturbing light region from the first set of disturbing light regions of interest detected in step (b);
(d) checking if disturbing light remains on the new set of images for the at least one disturbing light region and replace the at least one disturbing light region with corresponding disturbing light regions of interest from the new set of images; and
(e) repeating step (c) through (d) until no more detected disturbing light regions of interest are left or all poses of the external flashlight have been explored, then conduct labelled information label data recognition; wherein the labelled information label is a machine-readable code.

5. The method of claim 4, wherein said step of acquiring shelf images using external flashing includes use of an external flashlight, said external flashlight further comprising a multi-shot external flashlight, wherein the multi-shot external flashlight provides at least one different flashing condition on the shelf provided by varying positions of the multi-shot external flashlight around a shelf imager.
